(19) United States
(12) Patent Application Publication
(10) Pub. No.: US 2017/0249630 A1
(43) Pub. Date: Aug. 31, 2017

(54) GENERATING PAYMENT CARD DATA

(71) Applicant: TOUCH NETWORKS AUSTRALIA PTY LTD, Melbourne, Victoria (AU)

(72) Inventor: Jason Andrew VAN, Melbourne, Victoria (AU)

(21) Appl. No.: 15/503,347

(22) PCT Filed: Sep. 9, 2015
(86) PCT No.: PCT/AU2015/000554

§ 371 Date: Feb. 10, 2017

(30) Foreign Application Priority Data
Sep. 9, 2014 (AU) 2014903592

(51) Int. Cl. G06Q 20/34; G06Q 20/40

(52) U.S. Cl. CPC G06Q 20/34; G06Q 20/4018

(57) ABSTRACT

An electronic method of generating payment card data for a user comprises forming a payment card number by a) combining an issuer identification number (IIN) with at least a segment of a telephone number of the user and b) adding a check digit derived from the combination of the IIN and the at least a segment of a telephone number of the user; and generating an expiry date for the payment card using a random number generation process.

### FIELD

The present invention relates to a method of generating payment card data.

### BACKGROUND

Currently credit card numbers are generated by assigning an account number to a user, appending that account number to an issuer identification number (IIN) assigned to the issuer, and appending a check bit calculated from the combination of the account number and the IIN. Most credit cards also have an expiry date which is usually assigned based on a policy of the issuer as to how long the card should be active (e.g. a two year term). More recently, a card code verification (CCV) has been added to the credit card which is typically used for card not present transactions.

### SUMMARY

The invention provides an electronic method of generating payment card data for a user comprising:
forming a payment card number by a) combining an issuer identification number (IIN) with at least a segment of a telephone number of the user and b) adding a check digit derived from the combination of the IIN and the at least a segment of a telephone number of the user; and
generating an expiry date for the payment card using a random number generation process.

In an embodiment, the method comprises forming a card code verification number using a random number generation process.

In an embodiment, the process for forming a card code verification number is independent of the process for generating an expiry date.

In an embodiment, the telephone number comprises a mobile telephone number.

In an embodiment, the at least a segment of the user's telephone number comprises between six and twelve digits from the user's phone number.

In an embodiment, the six to twelve digits comprise the last six to twelve digits of the phone number.

In an embodiment, the segment comprises the last nine digits of the user's mobile telephone number.

In an embodiment, the method comprises storing the payment card data in a user database.

In an embodiment, the method comprises making a credit card with the payment card data.

Thus, the invention advantageously allows a user's phone number to be used as the basis for payment card data such as credit card data while minimising the risk of a person knowing the user's number fraudulently using their credit card.

The invention also provides an electronic system for generating payment card data for a user comprising:
a payment card number former arranged to form a payment card number by a) combining an issuer identification number (IIN) with at least a segment of a telephone number of the user, b) adding a check digit derived from the combination of the IIN and the at least a segment of a telephone number of the user; and
a first random processor arranged to generate an expiry date for the payment card using a random number generation process.

The invention also provide computer program code which implements the above method when executed on a computer. The computer program code may be provided on a tangible computer readable medium.

### BRIEF DESCRIPTION OF THE DRAWINGS

An embodiment of the invention will now be described in relation to the following drawings in which:

FIG. 1 is a block diagram of a credit card data generation system; and

FIG. 2 is a flow chart of a method of generating credit card data.

### DETAILED DESCRIPTION

Embodiments of the present invention relate to generating payment card data from a telephone number of a user. At least a random expiry date is generated for the payment card to mitigate against the potential security risk arising from a user's phone number potentially being available to a relatively large group of people.

In this specification, the term “random” and its grammatical equivalents includes pseudorandom processes unless the context indicates otherwise.

Payment card numbers are found on payment cards such as credit cards, debit cards, fixed value cards and reloadable value cards. Payment card numbers identify the card and the card issuer and are linked by issuing organisations to an account of the user; typically a bank account. Card numbers are most commonly sixteen digits in length and are formed from:
a six-digit Issuer Identification Number (IIN) (previously called the “Bank Identification Number” (BIN)) the first digit of which is the Major Industry Identifier (MII);
a variable length (up to twelve digits) individual account identifier,
a single check digit calculated using the Luhn algorithm.

In embodiments of the present invention, a segment of a user's phone number is used as the individual account identifier. In one example, the segment comprises the last nine digits of a user's mobile telephone number in order that the payment card number be sixteen digits long. In other embodiments a different sized segment could be employed, for example six to twelve digits (assuming the phone number has sufficient digits). It will be appreciated that the entirety of the phone number may be used. In some embodiments, additional padding digits may be used to produce a payment card number of desired length.

Referring to the drawings, there is shown an example of a system 100 for generating payment card data. In the embodiment, a user interface 130, such as a web portal, is accessed by a user who wishes to submit a request for a payment card, such as a credit card. In other embodiments, the user interface 130 could be provided to an employee of a card issuing company so that the employee can enter the request. Further, in other embodiments, it may not be necessary for there to be a user interface. For example, the system 100 could generate credit card data for all users for which they have a stored mobile telephone number.

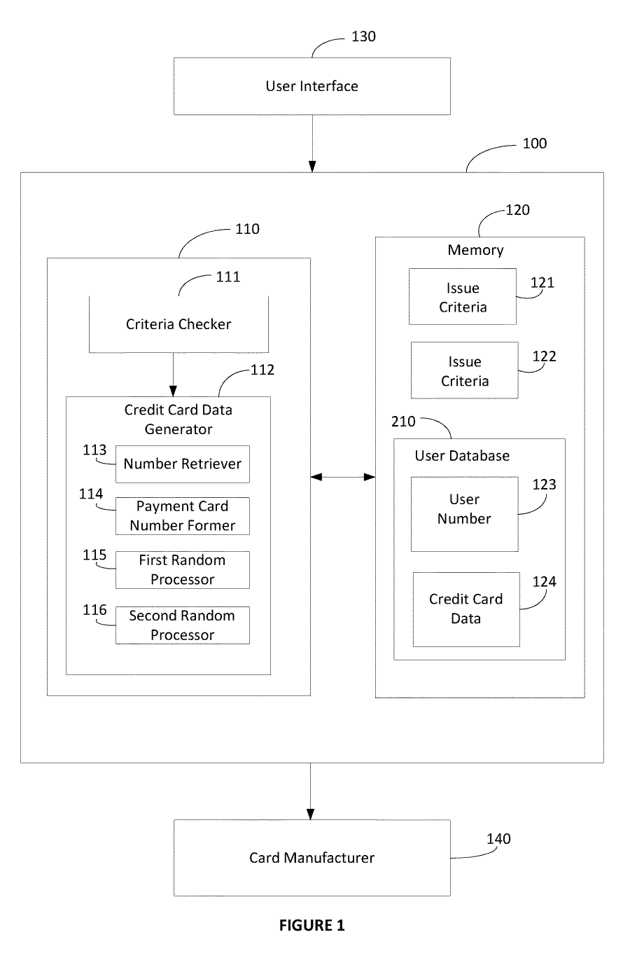

In the embodiment of FIG. 1, the system 100 comprises a number of modules 111-116 implemented by a processor 110 executing program code stored in memory 120. Persons skilled in the art will appreciate that these modules could be implemented differently, for example, across a number of different devices. The modules include a criteria checker 111 which responds to a user request received via the user interface to determine whether the user satisfies pre-set criteria stored as issue criteria 121 in memory 120 for a payment card to be issued. The issue criteria 121 may include that the user is registered with the system. The issue criteria 121 may also include that an account of the user indicates that the user has a good credit history.

Assuming the user satisfies the criteria 121, the credit card generator 122 generates credit card data for the user. In the embodiment, the credit card data generator includes a number retriever 113 for retrieving a user telephone number 123 from a user database 122 based on data input by the user which identifies the user. In other embodiments, the user may supply the user telephone number as part of the request process.

The payment card number former 114 combines a segment of the user's phone number with an issuer identification number and calculates a check digit from the result using a Luhn algorithm in order to generate a sixteen digit payment card number. In the embodiment, the segment of the phone number comprises the last nine digits of the user's mobile phone number.

A first random processor 115 then generates an expiry date for the card using a first random process independent of the user's payment card number. Using a random process independent of the payment card number avoids the risk of a person having access to a set of card numbers and expiry dates determining the algorithm employed in the random process.

It will be appreciated that a number of techniques can be used to determine the random expiry date. For example, in one embodiment, a number of months relative to a current month may be calculated within a defined range. This number of months can then be added to a current month to determine an expiry date.

A number of alternate techniques can be used, for example, the month may be calculated using a first sub-process of the random process and the year may be calculated using a second-sub sub process of the random process. In each embodiment, the process is constrained to ensure that the random process delivers a future date. In some embodiments, the random process can be constrained to ensure that the time before the card expires is within a defined minimum and or maximum date range.

In the embodiment, the payment card number is for a credit card. Accordingly, in the embodiment, a second random processor 116 calculates a card code verification number (CCV) via a second random process. In an advantageous embodiment, the CCV is calculated independently of the payment card number and the expiry date.

Accordingly, in one advantageous embodiment, the payment card data includes three separately calculated random numbers, namely the two parts of the expiry date and the CCV. The thus generated credit card data 124 is stored in user database 210.

In one embodiment, the component parts of the credit card data 124 are stored separately in the system 100 to avoid the risk of them being obtained by an unauthorized party. In one embodiment the credit card data 124 is separated into six components: the IIN, the phone number segment, the Luhn check bit, the month part of the expiry date, the year part of the expiry date, and the CCV. Each of these six components is allocated a transaction identifier. A primary identifier is linked to the user and when processed, enables the components to be temporarily assembled.

In another embodiment, the card code verification (CCV) number is calculated by encrypting the payment card number, expiration date and a service code with encryption keys known only to the card issuer, and decimalising the result. The CCV is used for “card not present” payment card transactions to reduce the incidence of credit card fraud. Typically the CCV is three or four digits long.

The CCV is also known by a number of other names including, a card security code (CSC), card verification data (CVD), card verification number (CVN), card verification value (CVV or CVV2), card verification value code (CVVC), card verification code (CVC or CVC2), verification code (V-code or V code), or signature panel code (SPC).

The payment card number, expiry date and CCV are in user database 122 as credit card data 124. The credit card data can also be sent to a card manufacturer 140 in order for the card to be made using standard processes.

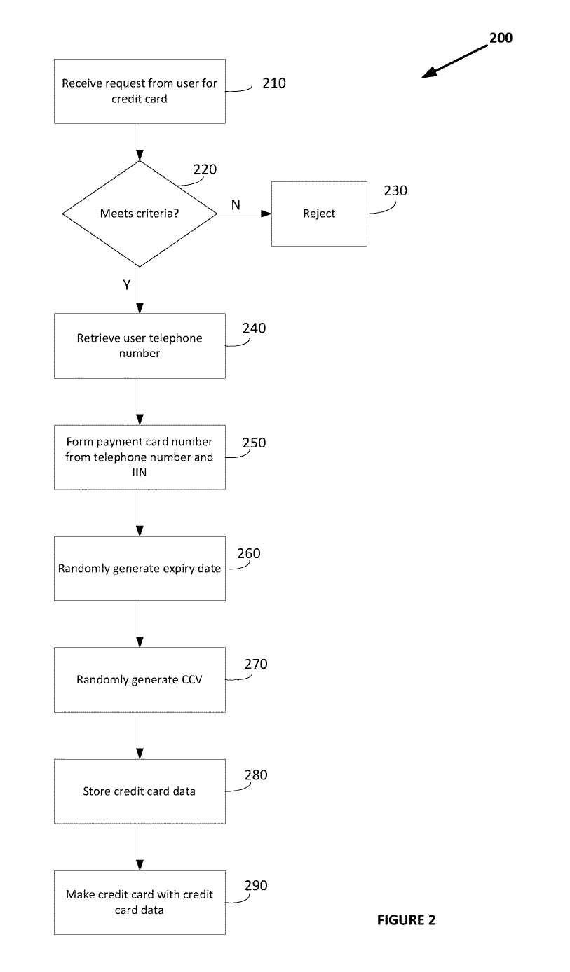

A method 200 of an embodiment is summarised in FIG. 2. The method 200 involves receiving a request from a user for a credit card 210, determining 220 whether the request meets criteria for issuing a payment card and if it doesn't meet criteria, rejecting the request 230. The method 200 then involves retrieving a user telephone number 240 forming a payment card number from the telephone number 250, randomly generating an expiry date 260, randomly generating a CCV 270 and storing 280 credit card data 124 in user database 210. The method may also involve making a credit card with the credit card data 290.

It will be appreciated that the method will be implemented electronically, for example, digitally by a processor executing program code. In this respect, in the above description certain steps are described as being carried out. It will be appreciated that such steps will often require a number of sub-steps to be carried out for the steps to be implemented electronically, for example due to hardware or programming limitations. For example, to carry out a step such as generating or determining, a processor may need to compute several values and perform processes on those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art will appreciate that program code provides a series of instructions executable by a processor.

Herein the term “processor” is used to refer generically to any device that can process game play instructions in accordance with game play rules and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An electronic method of generating payment card data for a user comprising:
forming a payment card number by a) combining an issuer identification number (IIN) with at least a segment of a telephone number of the user and b) adding a check digit derived from the combination of the TIN and the at least a segment of a telephone number of the user; and
generating an expiry date for the payment card using a random number generation process.

2. A method as claimed in claim 1, comprising forming a card code verification number using a random number generation process.

3. A method as claimed in claim 2, wherein the process for forming a card code verification number is independent of the process for generating an expiry date.

4. A method as claimed in claim 1, wherein the telephone number comprises a mobile telephone number.

5. A method as claimed in claim 1, wherein the at least a segment of the user's telephone number comprises between six and twelve digits from the user's phone number.

6. A method as claimed in claim 5, wherein the six to twelve digits comprise the last six to twelve digits of the phone number.

7. A method as claimed in claim 5, wherein the segment comprises the last nine digits of the user's mobile telephone number.

8. A method as claimed in claim 1, comprising storing the payment card data in a user database.

9. A method as claimed in claim 1, comprising making a credit card with the payment card data.

10. An electronic system for generating payment card data for a user comprising:
a payment card number former arranged to form a payment card number by a) combining an issuer identification number (IIN) with at least a segment of a telephone number of the user, b) adding a check digit derived from the combination of the IIN and the at least a segment of a telephone number of the user; and
a first random processor arranged to generate an expiry date for the payment card using a random number generation process.

11. A system as claimed in claim 10, comprising a second random processor arranged to form a card code verification number using a random number generation process.

12. A system as claimed in claim 11, wherein the second random processor arranged to form the card code verification number independently of the process for generating an expiry date.

13. A system as claimed in claim 10, wherein the telephone number comprises a mobile telephone number.

14. A system as claimed in claim 10, wherein the at least a segment of the user's telephone number comprises between six and twelve digits from the user's phone number.

15. A system as claimed in claim 14, wherein the six to twelve digits comprise the last six to twelve digits of the phone number.

16. A system as claimed in claim 14, wherein the segment comprises the last nine digits of the user's mobile telephone number.

17. (canceled)

18. A tangible computer readable medium comprising computer program code which, when executed by a processor, implements a method comprising:
forming a payment card number by a) combining an issuer identification number (IIN) with at least a segment of a telephone number of the user and b) adding a check digit derived from the combination of the IIN and the at least a segment of a telephone number of the user; and
generating an expiry date for the payment card using a random number generation process.
